(19) United States
(12) Patent Application Publication
(10) Pub. No.: US 2026/0285037 A1
(43) Pub. Date: Sep. 24, 2026

(54) LIQUID EJECTING HEAD AND LIQUID EJECTING APPARATUS

(71) Applicant: SEIKO EPSON CORPORATION, Tokyo (JP)

(72) Inventors: Takahiro KANEGAE, SHIOJIRI-SHI (JP); Yu SHIOZAWA, MINAMIMINOWA- MURA (JP); Hitoshi TAKAAI, AZUMINO-SHI (JP); Yoichi NAGANUMA, MATSUMOTO-SHI (JP)

(21) Appl. No.: 19/567,757

(22) Filed: Mar. 16, 2026

(30) Foreign Application Priority Data
Mar. 18, 2025 (JP) 2025-044107

(51) Int. Cl. B41J 2/14

(52) U.S. Cl. CPC B41J 2/14233; B41J 2/1433; B41J 2002/14306

(57) ABSTRACT

A flow path substrate provided with a nozzle flow path and a nozzle substrate provided with a nozzle are provided, in which the flow path substrate includes a protrusion portion, the protrusion portion is continuously provided over a first position and a second position at which the protrusion portion does not overlap the nozzle when viewed from a stack direction, and a third position at which the protrusion portion overlaps the nozzle when viewed in the stack direction, and a wall surface of the protrusion portion on one side at the third position is located on the one side with respect to a wall surface of the protrusion portion on the one side at the first position, and is located on the other side with respect to a wall surface of the protrusion portion on the one side at the second position.

The present application is based on, and claims priority from JP Application Serial Number 2025-044107, filed Mar. 18, 2025, the disclosure of which is hereby incorporated by reference herein in its entirety.

### BACKGROUND

### 1. Technical Field

The present disclosure relates to a liquid ejecting head and a liquid ejecting apparatus that eject a liquid, and an ink jet type recording head and an ink jet recording apparatus that eject an ink as a liquid.

### 2. Related Art

A liquid ejecting apparatus typified by an ink jet type printer or a liquid ejecting apparatus such as a plotter includes a liquid ejecting head which can eject a liquid such as an ink stored in a cartridge or a tank as a droplet. A liquid ejecting head includes a nozzle that ejects a liquid, a pressure chamber that communicates with the nozzle, and an energy generation element that generates a pressure fluctuation in the liquid in the pressure chamber, and ejects a droplet from the nozzle by generating the pressure fluctuation in the liquid in the pressure chamber by the energy generation element (for example, see JP-A-2023-72166).

Here, in a portion of the flow path directly above the nozzle, the liquid may be thickened by evaporation of a moisture at a nozzle interface, and the thickened liquid may be retained, so that there is a concern that an ejection failure of the liquid droplet may occur. On the other hand, it is known that a cross-sectional area of the flow path is locally reduced by providing a protrusion portion on the nozzle directly above the flow path, a flow velocity is increased, and the thickening of the liquid can be suppressed.

Meanwhile, depending on a shape of the protrusion portion, there is a problem that a flow rate is increased directly above the nozzle, a meniscus formed in the nozzle is pulled into the flow path, the meniscus is broken, and the ejection failure of the liquid droplet occurs, or air bubbles are mixed.

### SUMMARY

According to an aspect of the present disclosure, there is provided a liquid ejecting head including: a flow path in which a plurality of nozzle flow paths, through which a liquid flows and which extend in an extending direction, are arranged in an arrangement direction intersecting the extending direction; and a nozzle substrate in which a plurality of nozzles that are directly coupled to the nozzle flow paths and that eject liquids are arranged in the arrangement direction, the flow path substrate and the nozzle substrate being stacked in this order from one side to another side along a stack direction intersecting the arrangement direction and the extending direction, in which the flow path substrate has a protrusion portion protruding toward the other side along the stack direction, in one of the nozzle flow paths, the protrusion portion is continuously provided over a first position at which the protrusion portion does not overlap the nozzle when viewed in the stack direction, the first position being a position of an end portion on one side in the arrangement direction, a second position at which the protrusion portion does not overlap the nozzle when viewed in the stack direction, the second position being a position of an end portion on the other side in the arrangement direction, and a third position at which the protrusion portion overlaps the nozzle when viewed in the stack direction, the third position being a position between the first position and the second position in the arrangement direction, and a wall surface of the protrusion portion on one side in the extending direction at the third position is located on the one side in the extending direction with respect to a wall surface of the protrusion portion on the one side in the extending direction at the first position, and is located on the other side in the extending direction with respect to a wall surface of the protrusion portion on the one side in the extending direction at the second position.

According to another aspect of the present disclosure, there is provided a liquid ejecting apparatus including: the liquid ejecting head according to the aspect described above; and a control section that controls an ejection operation of the liquid ejecting head.

### BRIEF DESCRIPTION OF THE DRAWINGS

FIG. 1 is an exploded perspective view of a liquid ejecting head according to Embodiment 1.

FIG. 2 is a plan view of a main portion of a pressure chamber substrate and a communication plate according to Embodiment 1.

FIG. 3 is a cross-sectional view of a liquid ejecting head according to Embodiment 1.

FIG. 4 is a cross-sectional view of a main portion of the liquid ejecting head according to Embodiment 1.

FIG. 5 is a cross-sectional view of a main portion of the liquid ejecting head according to Embodiment 1.

FIG. 6 is a cross-sectional view of a main portion of the liquid ejecting head according to Embodiment 1.

FIG. 7 is a plan view of a pressure chamber and a protrusion portion according to Embodiment 1.

FIG. 8 is a plan view of a pressure chamber and a protrusion portion according to Comparative Example.

FIG. 9 is a view illustrating a schematic configuration of a liquid ejecting apparatus according to one embodiment.

### DESCRIPTION OF EMBODIMENTS

The present disclosure will be described in detail below based on embodiments. However, the following description illustrates one aspect of the present disclosure, and can be modified as desired within the scope of the present disclosure. In each drawing, the same reference numerals indicate the same members, and the description thereof will be omitted as appropriate. In addition, in each drawing, X, Y, and Z represent three spatial axes that are orthogonal to each other. In the present specification, directions along these axes will be referred to as an X direction, a Y direction, and a Z direction. In each drawing, a direction indicated by an arrow is a positive (+) direction, and a direction opposite to the arrow is a negative (−) direction. The Z direction indicates a vertical direction, the +Z direction indicates a vertically downward direction, and the −Z direction indicates a vertically upward direction. Furthermore, directions along the three spatial axes of which the positive direction and the negative direction are not limited will be referred to as an X-axis direction, a Y-axis direction, and a Z-axis direction.

### Embodiment 1

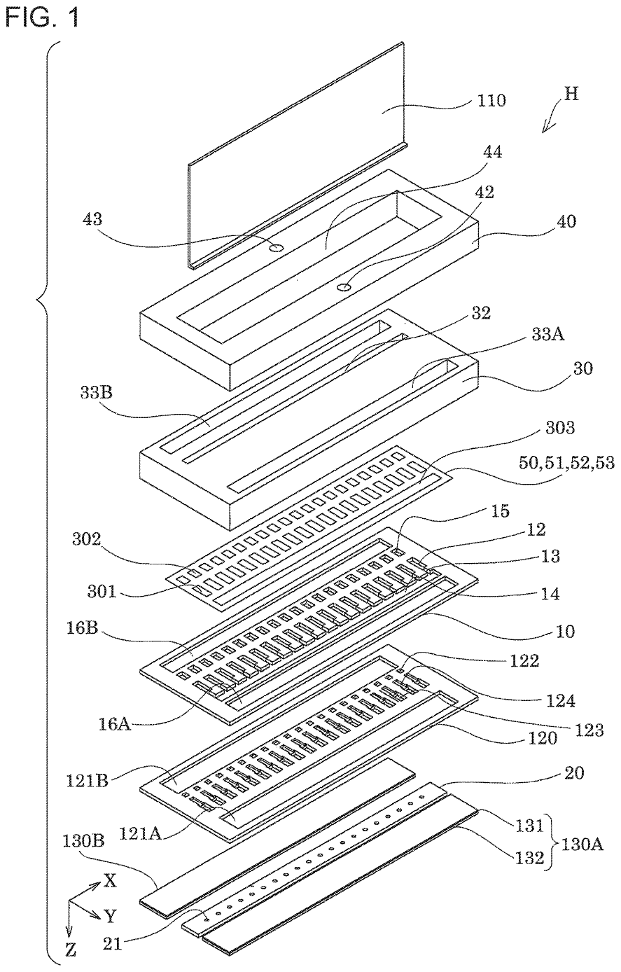

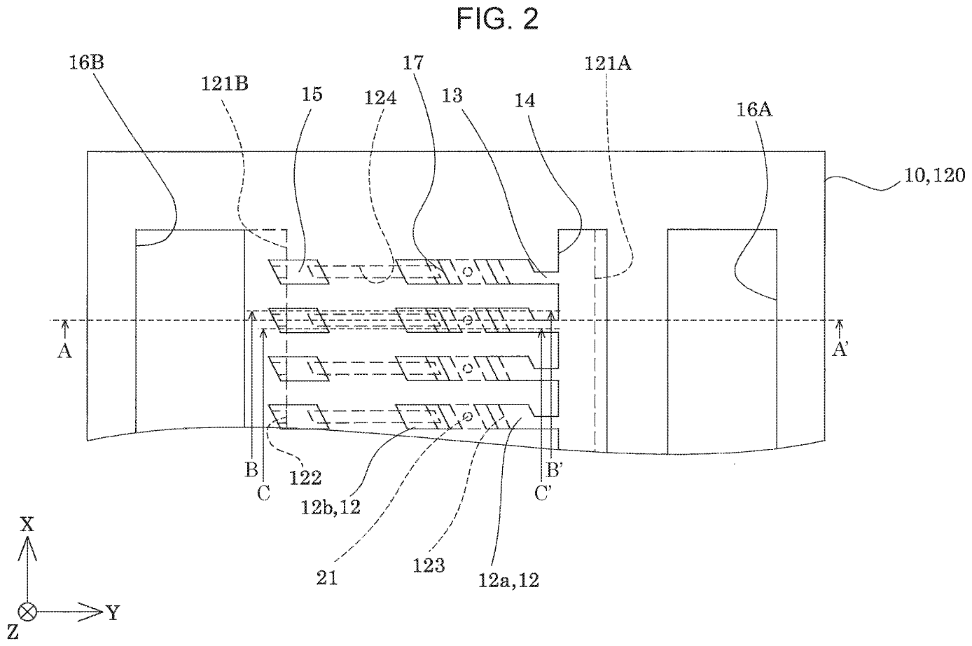

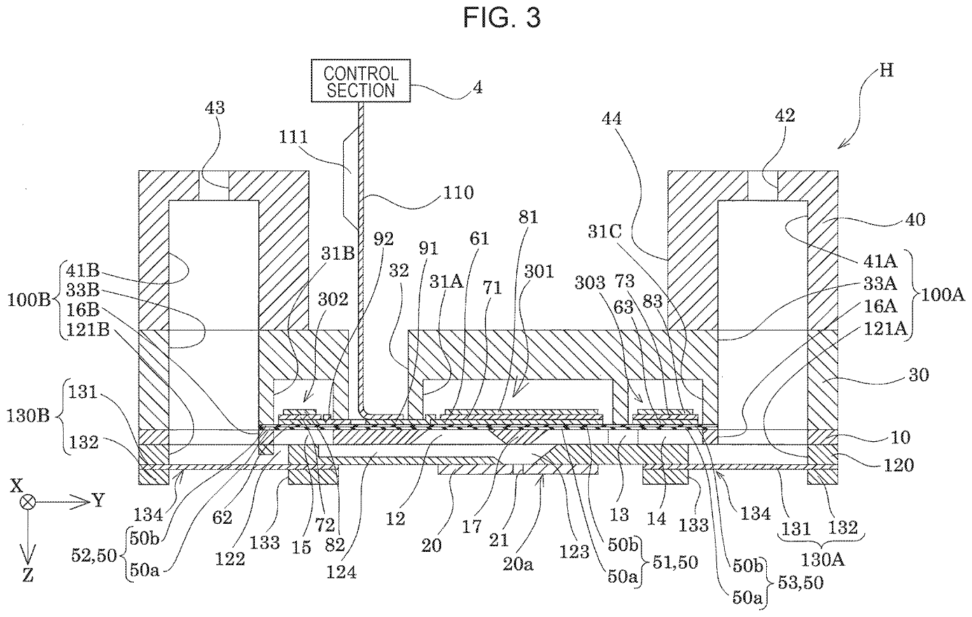

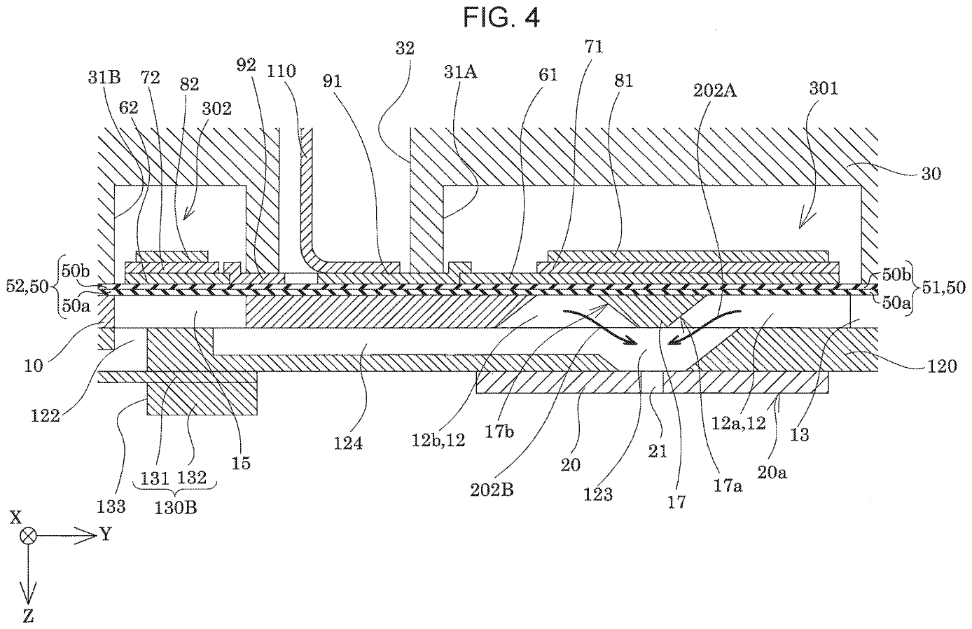

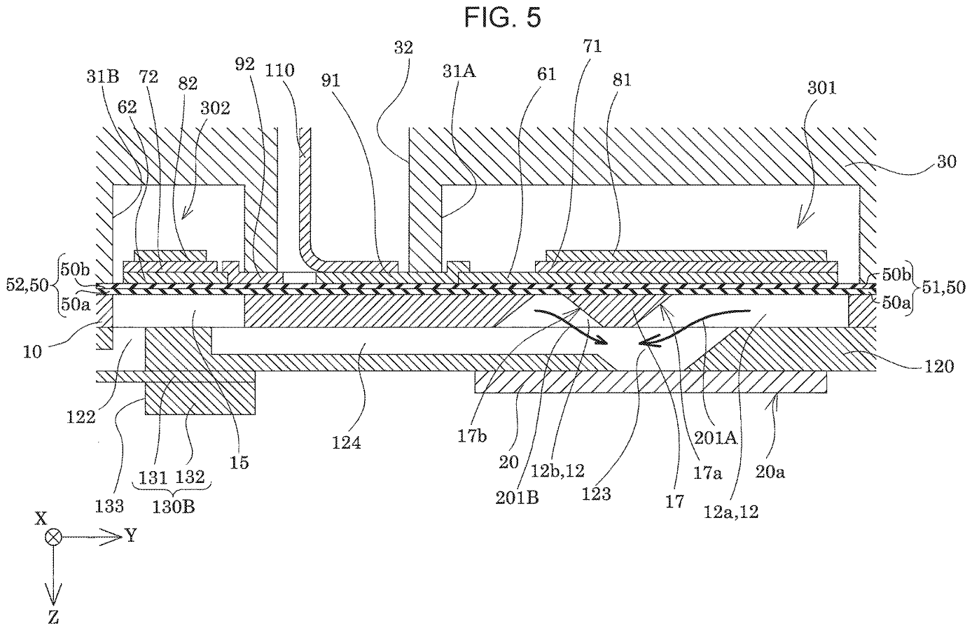

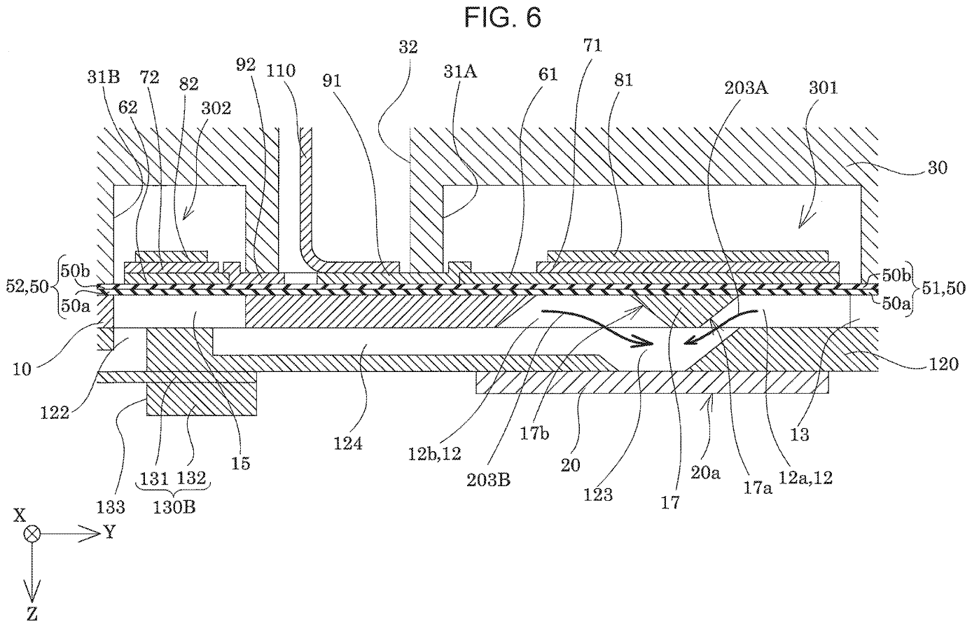

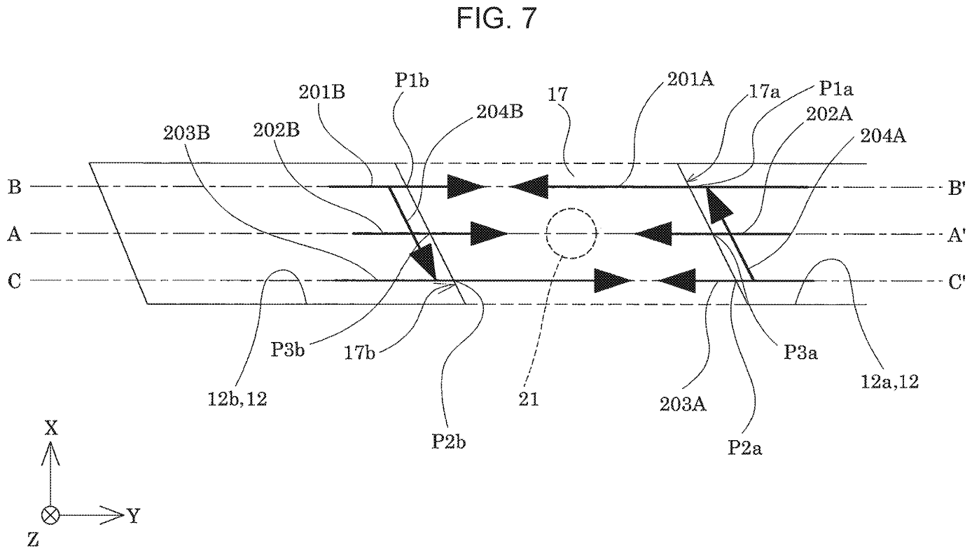

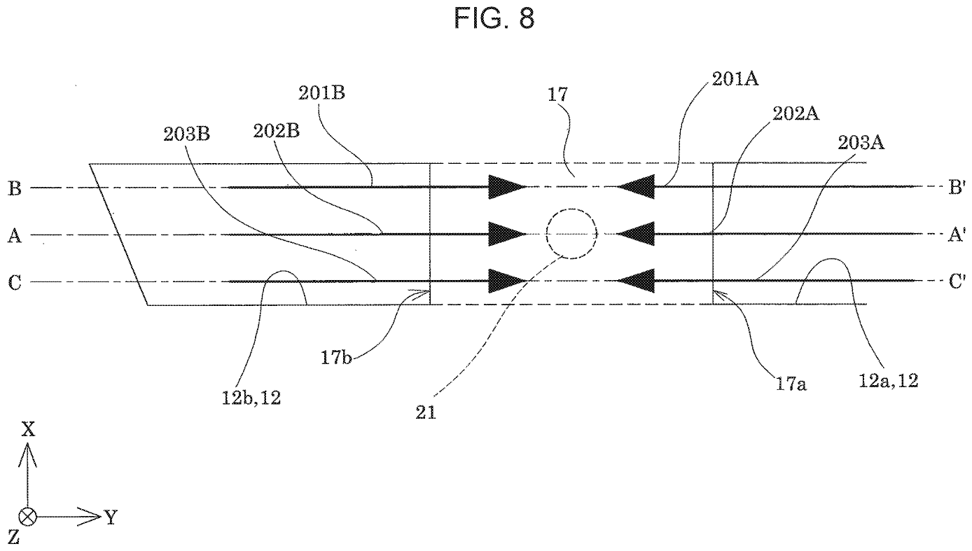

FIG. 1 is an exploded perspective view of a liquid ejecting head H according to Embodiment 1 of the present disclosure. FIG. 2 is a plan view of a pressure chamber substrate 10 and a communication plate 120 when viewed in the +Z direction. FIG. 3 is a cross-sectional view of the liquid ejecting head H including a line A-A′ in FIG. 2. FIG. 4 is an enlarged view of a main portion in FIG. 3. FIG. 5 is a cross-sectional view of a main portion of the liquid ejecting head H including a line B-B′ in FIG. 2. FIG. 6 is a cross-sectional view of the main portion of the liquid ejecting head H including a line C-C′ in FIG. 2. FIG. 7 is a plan view of a pressure chamber 12 and a protrusion portion 17 when viewed in the +Z direction. FIG. 8 is a plan view of the pressure chamber 12 and the protrusion portion 17 of Comparative Example when viewed in the +Z direction.

The liquid ejecting head H is configured as a head for ejecting inks in a printer. The ink is guided to the liquid ejecting head H, and a part thereof is ejected from a nozzle 21 to an outside, for example, to a printing medium. Since the ink is circulated, the ink which is not ejected from the nozzle 21 is discharged from the liquid ejecting head H. Therefore, in the present specification, the terms “supply-side” and “discharge-side” may be used. The term “supply-side” indicates upstream from a pressure chamber, which will be described below, with respect to a flow path of a liquid. In addition, a part related to upstream from the pressure chamber may be referred to as the “supply-side”. The “discharge-side” indicates downstream of the pressure chamber 12 with respect to the flow path of the liquid. The term “discharge-side” does not include the nozzle 21 to be described below. In addition, a part related to downstream from the pressure chamber 12 may be referred to as the “discharge-side”. In addition, the “discharge-side” may be referred to as a “collection-side”. The liquid is not limited to the ink, and the liquid ejecting head H can be configured to eject other liquids.

As illustrated in the drawing, the liquid ejecting head H includes a nozzle substrate 20, the communication plate 120, the pressure chamber substrate 10, a protective substrate 30, and a case 40 in this order in the −Z direction.

The pressure chamber substrate 10 is made of, for example, a silicon substrate, a glass substrate, an SOI substrate, or various ceramic substrates.

In the pressure chamber substrate 10, a plurality of pressure chambers 12 are disposed side by side along the X-axis direction. The plurality of pressure chambers 12 are disposed on a straight line along the X-axis direction to be at the same position in the Y-axis direction (that is, to be at an overlapping position when viewed in the X-axis). The two pressure chambers 12 adjacent to each other in the X-axis direction are partitioned by a partition wall. Each of the plurality of pressure chambers 12 is formed by a through-hole penetrating the pressure chamber substrate 10 in the Z-axis direction from a surface facing the −Z direction to a surface facing the +Z direction, of the pressure chamber substrate 10. Here, the “through-hole” is a space defined by a side surface coupled to a surface of the pressure chamber substrate 10 facing the +Z direction from a surface of the pressure chamber substrate 10 facing the −Z direction. The side surface may be a surface inclined with respect to the Z-axis direction, that is, the through-hole may be defined by the inclined surface. In the present embodiment, the pressure chamber 12 constitutes a part of a nozzle flow path that communicates with the nozzle 21.

Further, the pressure chamber substrate 10 includes an ink supply path 13 communicating with one end portion side of the pressure chamber 12 in the +Y direction, for each pressure chamber 12. The ink supply path 13 is defined in a through-hole penetrating the pressure chamber substrate 10 in the Z-axis direction, is formed with a width narrower than a width of the pressure chamber 12 in the X-axis direction, and maintains a flow path resistance of the ink flowing into the pressure chamber 12 from the upstream at a constant level. That is, the ink supply path 13 functions as a so-called throttle portion. The ink supply path 13 is not limited to the configuration in which the width in the X-axis direction is reduced, and may have a configuration in which a height in the Z-axis direction is reduced. The pressure chamber 12 refers to a portion up to a coupling port coupled to the ink supply path 13. In addition, a surface of the pressure chamber 12 and the ink supply path 13 in the −Z direction is defined by a first diaphragm 51.

Further, the pressure chamber substrate 10 has an absorption chamber 14 that communicates with the pressure chamber 12 of the ink supply path 13 at the other end portion opposite to one end portion in the Y-axis direction, that is, an end portion side in the +Y direction. The absorption chamber 14 is defined by a through-hole penetrating the pressure chamber substrate 10 in the Z-axis direction. The pressure chamber 12 and the absorption chamber 14 communicate with each other via the ink supply path 13. The absorption chamber 14 is continuously provided over a plurality of ink supply paths 13 along the X-axis direction. The absorption chamber 14 is defined by a third diaphragm 53 in the −Z direction. Such an absorption chamber 14 functions as a damper for absorbing vibration of inks. The absorption chamber 14 is not always necessary, and the absorption chamber 14 may not be provided.

The pressure chamber substrate 10 has a detection chamber 15 on the −Y direction side opposite to the ink supply path 13 of the pressure chamber 12 in the Y-axis direction, at a position separated from the pressure chamber 12 in the Y-axis direction. The detection chamber 15 is defined by a through-hole penetrating the pressure chamber substrate 10 in the Z-axis direction. A plurality of detection chambers 15 are disposed side by side along the X-axis direction. That is, the plurality of detection chambers 15 are disposed on a straight line along the X-axis direction to be at the same position in the Y-axis direction. The two detection chambers 15 adjacent to each other in the X-axis direction are partitioned by a partition wall. In the present embodiment, the detection chambers 15 are disposed to have the same width as the width of the pressure chamber 12 in the X-axis direction and the same pitch as a pitch of the pressure chamber 12 in the X-axis direction. The detection chamber 15 is provided to have a length shorter than a length of the pressure chamber 12 in the Y-axis direction. Incidentally, the width and the length of the pressure chamber 12 and the detection chamber 15 are dimensions on a surface defined by the diaphragm, that is, a surface in the −Z direction. In addition, a surface of the detection chamber 15 in the −Z direction is defined by a second diaphragm 52. The detection chamber 15 is not always necessary, and the detection chamber 15 may not be provided.

In addition, the pressure chamber substrate 10 is formed with flow paths 16A and 16B constituting a part of common liquid chambers 100A and 100B through which the plurality of pressure chambers 12 communicate in common, on both end portions of the pressure chamber substrate 10 in the Y-axis direction, that is, on both outer sides of the pressure chamber 12, the absorption chamber 14, and the detection chamber 15. In the present embodiment, the liquid ejecting head H is formed with the supply-side common liquid chamber 100A and the discharge-side common liquid chamber 100B, and the pressure chamber substrate 10 is provided with the flow path 16A constituting a part of the supply-side common liquid chamber 100A and the flow path 16B constituting a part of the discharge-side common liquid chamber 100B. The flow paths 16A and 16B are provided to penetrate the pressure chamber substrate 10 in the Z-axis direction.

The communication plate 120 and the nozzle substrate 20 are sequentially stacked on a surface of the pressure chamber substrate 10 facing the +Z direction.

The communication plate 120 has flow paths 121A and 121B constituting a part of each of the common liquid chambers 100A and 100B. The flow path 121A is a flow path that constitutes a part of the supply-side common liquid chamber 100A, and is provided to penetrate the communication plate 120 in the Z-axis direction, at a position overlapping the flow path 16A of the pressure chamber substrate 10 when viewed in the Z-axis direction. Further, the flow path 121A is extended in the −Y direction to a position overlapping the end portion of the absorption chamber 14 in the +Y direction when viewed in the Z-axis direction. Therefore, the flow path 121A communicates with the absorption chamber 14 of the pressure chamber substrate 10 in the Z-axis direction at an end portion in the −Y direction. The flow path 121B is a flow path that constitutes a part of the discharge-side common liquid chamber 100B, and is provided to penetrate the communication plate 120 in the Z-axis direction at a position overlapping the flow path 16B of the pressure chamber substrate 10 when viewed in the Z-axis direction. Further, the flow path 121B is extended in the +Y direction to a position overlapping an end portion of the detection chamber 15 in the −Y direction when viewed in the Z-axis direction. The portion of the flow path 121B, which is extended in the +Y direction, has a recessed shape that opens on a surface facing the +Z direction without penetrating the communication plate 120 in the Z-axis direction. The communication plate 120 is provided with a discharge communication path 122 that communicates the detection chamber 15 and the flow path 121B, and the ink in the detection chamber 15 is discharged to the flow path 121B via the discharge communication path 122.

Further, the communication plate 120 includes a nozzle communication portion 123 that individually communicates each pressure chamber 12 and each nozzle 21, and a collection path 124 for collecting the ink in the nozzle communication portion 123 and the pressure chamber 12 to the outside of the liquid ejecting head H.

The nozzle communication portion 123 is defined by a through-hole penetrating the communication plate 120 in the Z-axis direction. A plurality of nozzle communication portions 123 are disposed side by side along the X-axis direction. That is, the plurality of nozzle communication portions 123 are disposed on a straight line along the X-axis direction to be at the same position in the Y-axis direction. The two nozzle communication portions 123 adjacent to each other in the X-axis direction are partitioned by a partition wall. In the present embodiment, the nozzle communication portion 123 is disposed to have substantially the same width as the width of the pressure chamber 12 in the X-axis direction and to have the same pitch as the pitch of the pressure chamber 12 in the X-axis direction. That is, the nozzle communication portion 123 is provided independently for each of the pressure chambers 12.

In such a nozzle communication portion 123, an end portion in the −Z direction directly communicates with the pressure chamber 12, and an end portion in the +Z direction directly communicates with the nozzle 21. That is, the nozzle 21 is directly coupled to the nozzle communication portion 123. The nozzle communication portion 123 is configured to allow the ink to flow therein and forms a part of a nozzle flow path extending in the Y-axis direction.

In addition, the nozzle communication portion 123 of the present embodiment is provided with a width in the Y-axis direction that is gradually decreased in the +Z direction. That is, side surfaces of the nozzle communication portion 123 on both sides in the Y-axis direction are inclined surfaces inclined in the Z-axis direction. Specifically, the side surface of the nozzle communication portion 123 in the −Y direction is formed of an inclined surface that is inclined toward the −Z direction as going in the −Y direction. In addition, the side surface of the nozzle communication portion 123 in the +Y direction is formed of an inclined surface that is inclined toward the −Z direction as going in the +Y direction. Therefore, when the ink flows from the pressure chamber 12 into the nozzle communication portion 123 along the Y-axis direction and the Z-axis direction, and when the ink flows out from the nozzle communication portion 123 into the pressure chamber 12, the ink can smoothly flow without being retained.

The collection path 124 is defined by a recess portion that is recessed in the +Z direction from a surface of the communication plate 120 facing the −Z direction and is coupled to the nozzle communication portion 123. The collection path 124 of the present embodiment opens to the surface of the communication plate 120 facing the −Z direction and does not open to a surface of the communication plate 120 facing the +Z direction, that is, is provided in a part of a thickness in the Z-axis direction without penetrating the communication plate 120 in the Z-axis direction. Therefore, the recess portion forming the collection path 124 does not open to the surface of the communication plate 120 facing the +Z direction. That is, the collection path 124 is not defined by the nozzle substrate 20 fixed to the surface of the communication plate 120 in the +Z direction. Such a collection path 124 is provided independently for each of the pressure chambers 12, that is, a plurality of collection paths 124 are provided independently in the X-axis direction. Further, the collection path 124 extends in the −Y direction from a coupling port with the nozzle communication portion 123. That is, when viewed in the +Z direction, the absorption chamber 14 and the ink supply path 13 constituting the supply path, the pressure chamber 12 and the nozzle communication portion 123, and the collection path 124 are disposed side by side in the −Y direction.

One end of the collection path 124 in the +Y direction communicates with the nozzle communication portion 123, and the other end in the −Y direction is extended to a position overlapping an end portion of the detection chamber 15 in the +Y direction when

### Viewed in the Z-axis Direction.

A width of the collection path 124 in the X-axis direction may be smaller than a width of the nozzle communication portion 123, or may be the same as the width of the nozzle communication portion 123. By setting the width of the collection path 124 in the X-axis direction to be smaller than the width of the nozzle communication portion 123, a flow path cross-sectional area of the collection path 124 can be reduced, and a flow velocity of the ink flowing in the collection path 124 can be increased. Therefore, air bubbles in the collection path 124 can be easily discharged from the collection path 124 to the outside. In addition, by setting the width of the collection path 124 in the X-axis direction to the same width as the nozzle communication portion 123, a step due to a width difference is not formed at a coupling portion of the nozzle communication portion 123 and the collection path 124, and occurrence of a problem in which the air bubbles are caught in the step and the air bubbles are not discharged can be suppressed.

The collection path 124 is coupled to the pressure chamber 12 in a region overlapping the pressure chamber 12 when viewed in the +Z direction. That is, since the collection path 124 is provided to open to the surface of the communication plate 120 facing the −Z direction, and the pressure chamber 12 is extended in the −Y direction from the nozzle communication portion 123, an opening of a surface of the communication plate 120 of the collection path 124, which faces the −Z direction, and a portion of the pressure chamber 12, which is extended in the −Y direction from the nozzle communication portion 123, communicate with each other in the Z-axis direction. In this manner, by directly coupling the collection path 124 to the pressure chamber 12, even when the air bubbles enter the pressure chamber 12 from the nozzle communication portion 123, the air bubbles in the pressure chamber 12 can be discharged to the collection path 124. Incidentally, when the collection path 124 is coupled to the nozzle communication portion 123 without being directly coupled to the pressure chamber 12, the air bubbles entering the pressure chamber 12 need to move to the collection path 124 via the nozzle communication portion 123, which is difficult.

The nozzle substrate 20 is a plate-shaped member joined to a surface of the pressure chamber substrate 10 opposite to the communication plate 120, that is, the surface facing the +Z direction. A plurality of nozzles 21 that communicate with each pressure chamber 12 via the nozzle communication portion 123 are formed in the nozzle substrate 20. In the present embodiment, the plurality of nozzles 21 are disposed side by side in a row along the X-axis direction. As such a nozzle substrate 20, a silicon substrate or an SOI substrate is preferably used. The material of the nozzle substrate 20 is not limited thereto, and a glass substrate, various ceramic substrates, a metal substrate such as a stainless steel substrate, or an organic material such as polyimide resin may be used. In the present embodiment, a surface of the nozzle substrate 20 facing the +Z direction in which the nozzle 21 opens is referred to as a nozzle surface 20a.

In such a flow path configuration, the ink in the common liquid chamber 100A is supplied to the nozzle 21 via the absorption chamber 14, the ink supply path 13, the pressure chamber 12, and the nozzle communication portion 123. The ink that is not ejected from the nozzle 21 in the pressure chamber 12 and the nozzle communication portion 123 is collected in the common liquid chamber 100B via the collection path 124, the detection chamber 15, and the discharge communication path 122. That is, in the present embodiment, an “individual supply flow path” which communicates with the nozzle 21 and through which the ink is supplied to the nozzle 21 includes the ink supply path 13. In addition, an “individual discharge flow path” that communicates with the nozzle 21 and collects the ink that is not ejected from the nozzle 21 includes the collection path 124 and the detection chamber 15. When the discharge communication path 122 is provided independently for each detection chamber 15, the individual discharge flow path includes the discharge communication path 122. Further, the discharge communication path 122 may be continuously provided over the plurality of detection chambers 15, that is, in the X-axis direction. In the present embodiment, the individual supply flow path, the individual discharge flow path, the pressure chamber 12, the nozzle communication portion 123, and the nozzle 21 are collectively referred to as an “individual flow path”. Further, a flow path in which a plurality of individual flow paths communicate with each other in common is referred to as a “common flow path”, a common flow path on the supply-side is referred to as a “common supply flow path”, and a common flow path on the discharge-side is referred to as a “common discharge flow path”. In the present embodiment, the “common supply flow path” includes the common liquid chamber 100A, and the “common discharge flow path” includes the common liquid chamber 100B. In this manner, the detection chamber 15 and the pressure chamber 12 form a part of the individual flow path instead of the common flow path, so that residual vibration in each pressure chamber 12 can be individually detected in the detection chamber 15, and an ejection failure of each nozzle 21 can be individually detected. Further, by constituting a part of the individual discharge flow path with the detection chamber 15, a flow path length of the individual supply flow path can be shortened, as compared with a case where the detection chamber 15 is provided to constitute a part of the individual supply flow path. Therefore, by shortening the flow path length of the individual supply flow path, a pressure loss can be reduced and occurrence of a problem in which the ink is not supplied to the pressure chamber 12 can be suppressed.

In the present embodiment, the collection path 124 is coupled to the nozzle communication portion 123 in the +Z direction with respect to the pressure chamber 12. Therefore, air bubbles which are pulled out from the nozzle 21 and enter the nozzle communication portion 123 and air bubbles which enter the nozzle communication portion 123 from the ink supply path 13 can be discharged to the collection path 124 before the air bubbles float up in the pressure chamber 12 due to buoyancy. Therefore, an air-bubble discharge property can be improved by the collection path 124.

Further, the liquid ejecting head H has the protrusion portion 17 protruding from a diaphragm 50 in the +Z direction. In the present embodiment, the protrusion portion 17 is formed in a part of the pressure chamber substrate 10. That is, a height of the protrusion portion 17 in the +Z direction from the diaphragm 50 is the same as a thickness of the pressure chamber substrate 10. However, the height of the protrusion portion 17 in the Z direction from the diaphragm 50 may be shorter than the thickness of the pressure chamber substrate 10. The protrusion portion 17 is provided in the vicinity (directly above) of the nozzle 21. The protrusion portion 17 is provided continuously over the width of the pressure chamber 12 in the X-axis direction, that is, from the partition walls on both sides, which define the pressure chamber 12. Therefore, the protrusion portion 17 separates the pressure chamber 12 into a portion in the +Y direction and a portion in the −Y direction. In the present embodiment, a part of the pressure chamber 12 on the supply-side with respect to the protrusion portion 17, that is, in the +Y direction is referred to as a first pressure chamber 12a, and a part of the pressure chamber 12 on the discharge-side, that is, in the −Y direction is referred to as a second pressure chamber 12b.

By providing the protrusion portion 17, a cross-sectional area along the +Z direction of the flow path between the protrusion portion 17 and the nozzle 21, that is, a cross-sectional area crossing the Y-axis direction is reduced, in the vicinity of the nozzle 21. Therefore, a flow velocity of the ink between the protrusion portion 17 and the nozzle 21 is increased, and thickening of the ink in the vicinity of the nozzle 21 due to the evaporation of the moisture contained in the ink from the nozzle 21 can be suppressed. In addition, the flow velocity of the ink between the protrusion portion 17 and the nozzle 21 is increased, so that mixed air bubbles between the protrusion portion 17 and the nozzle 21 are likely to flow into the collection path 124. Therefore, the air bubbles in the nozzle communication portion 123 can be easily discharged through the collection path 124, and the air-bubble discharge property can be improved.

In addition, both sides of the protrusion portion 17 in the Y-axis direction are defined by a first surface 17a and a second surface 17b. The first surface 17a defines a wall surface of the protrusion portion 17 in the +Y direction, and the second surface 17b defines a wall surface of the protrusion portion 17 in the −Y direction.

The nozzle flow path of the present embodiment is configured with the first pressure chamber 12a, the second pressure chamber 12b, and the nozzle communication portion 123 described above. That is, the nozzle flow path includes the first pressure chamber 12a, the second pressure chamber 12b, and the nozzle communication portion 123 in the present embodiment. In addition, the nozzle flow path extends in a left-right direction, that is, in the Y-axis direction in FIGS. 4 to 6. In the nozzle flow path of the present embodiment, the ink supplied from the ink supply path 13 flows from the first pressure chamber 12a to the second pressure chamber 12b through the nozzle communication portion 123. That is, the ink flows from the +Y direction side in the Y-axis direction to the −Y direction side, that is, in the −Y direction in the ink flow path. In this manner, an extending direction of the nozzle flow path is a direction in which the ink flows inside in the XY plane defined by the X-axis direction and the Y-axis direction.

In addition, the first surface 17a extends in a direction intersecting both the Y-axis direction and the Z-axis direction when viewed in the X-axis direction. In the present embodiment, the first surface 17a is an inclined surface that is inclined in the −Z direction as going in the +Y direction. In addition, the second surface 17b extends in a direction intersecting both the Y-axis direction and the Z-axis direction when viewed in the X-axis direction. In the present embodiment, the second surface 17b is an inclined surface that is inclined in the −Z direction as going in the −Y direction. That is, the protrusion portion 17 has a trapezoidal shape in which an end portion in the +Z direction is narrow in a cross section illustrated in FIGS. 4 to 6. Of course, one or both of the first surface 17a and the second surface 17b of the protrusion portion 17 may be a surface along the Z-axis direction when viewed in the X-axis direction.

In this manner, by extending the first surface 17a of the protrusion portion 17 in the direction intersecting both the Y-axis direction and the Z-axis direction, when the ink flows from the first pressure chamber 12a into the nozzle communication portion 123, retention of the ink can be suppressed and the ink can smoothly flow. Of course, even when the ink flows from the second pressure chamber 12b to the nozzle communication portion 123, the retention of the ink can be suppressed, and the ink can smoothly flow.

Further, by extending the second surface 17b of the protrusion portion 17 in a direction intersecting both the Y-axis direction and the Z-axis direction, when the ink flows from the nozzle communication portion 123 to the second pressure chamber 12b, the retention of the ink can be suppressed and the ink can smoothly flow. Of course, even when the ink flows from the second pressure chamber 12b to the nozzle communication portion 123, the retention of the ink can be suppressed, and the ink can smoothly flow.

The protrusion portion 17 is continuously provided over a first position, which is a position of an end portion in the +X direction, a second position, which is a position of an end portion in the −X direction, and a third position between the first position and the second position in the X-axis direction. In FIG. 2, a portion of the protrusion portion 17 along the line B-B′ is the first position, a position along the line C-C′ is the second position, and a position along the line A-A′ is the third position. Hereinafter, the first position, the second position, and the third position are respectively referred to as a first position B-B', a second position C-C', and a third position A-A'. As will be described in detail below, the third position A-A′ is a portion that overlaps the nozzle 21 when viewed in the +Z direction. In other words, the third position A-A′ is a position in the X-axis direction in which a straight line drawn along the Y-axis direction overlaps both the protrusion portion 17 and the nozzle 21. On the other hand, the first position B-B′ and the second position C-C′ are portions that do not overlap the nozzle 21 when viewed in the +Z direction. In other words, the first position B-B′ and the second position C-C′ are positions in the X-axis direction in which a straight line drawn along the Y-axis direction overlaps the protrusion portion 17 but does not overlap the nozzle 21.

The first position, the second position, and the third position of the protrusion portion 17 in the X-axis direction are not limited to the positions that overlap the straight line along the Y-axis direction, and may be a region having a predetermined width in the X-axis direction. That is, a region of an end portion of the protrusion portion 17 in the +X direction may be the first position, a region of an end portion in the −X direction may be the second position, and a region between the first position and the second position in the X-axis direction may be the third position. When the region is set to have the predetermined width in the X-axis direction in this manner, the third position is a portion along the Y-axis direction including a portion overlapping the nozzle 21 when viewed in the +Z direction, and the first position and the second position are portions along the Y-axis direction including a portion not overlapping the nozzle 21 when viewed in the +Z direction.

As illustrated in FIGS. 5 and 6, the protrusion portion 17 does not overlap the nozzle 21 in a plan view when viewed in the Z-axis direction at the first position B-B′ and the second position C-C′. In addition, as illustrated in FIG. 4, the protrusion portion 17 overlaps the nozzle 21 in a plan view when viewed in the Z-axis direction at the third position A-A′. Here, the protrusion portion 17 not overlapping the nozzle 21 in a plan view when viewed in the Z-axis direction means that the nozzle 21 is not displayed when the liquid ejecting head H is cut in the YZ plane defined in the Y-axis direction and the Z-axis direction at each of the first position B-B′ and the second position C-C′ as illustrated in FIGS. 5 and 6.

As illustrated in FIG. 7, a wall surface P3a in the +Y direction, which is one side of the protrusion portion 17 in the Y-axis direction at the third position A-A′, is located in the +Y direction with respect to a wall surface P1a in the +Y direction, which is one side of the protrusion portion 17 in the Y-axis direction at the first position B-B′.

As illustrated in FIG. 7, the wall surface P3a in the +Y direction, which is one side of the protrusion portion 17 in the Y-axis direction at the third position A-A′, is located in the −Y direction with respect to a wall surface P2a in the +Y direction, which is one side of the protrusion portion 17 in the Y-axis direction at the second position C-C′.

The first surface 17a of the present embodiment is an inclined surface that is inclined in the −Z direction as going in the +Y direction as illustrated in FIGS. 4 and 5. Therefore, in the present embodiment, the wall surface P1a in the +Y direction at the first position B-B′, the wall surface P2a in the +Y direction at the second position C-C′, and the wall surface P3a in the +Y direction at the third position A-A′ are referred to as a center position of the first surface 17a inclined with respect to the Z-axis direction.

In the present embodiment, as illustrated in FIG. 7, a position of the protrusion portion 17 on the +Y direction side is gradually changed in the −Y direction as a position in the X-axis direction is changed to the second position C-C′, the third position A-A′, and the first position B-B′. That is, the first surface 17a of the protrusion portion 17 in the +Y direction is an inclined surface that is inclined toward the −Y direction as going toward the second position C-C′, the third position A-A′, and the first position B-B′, that is, as going toward the +X direction.

As illustrated in FIG. 7, in the second surface 17b, a wall surface P3b in the −Y direction, which is the other side of the protrusion portion 17 in the Y-axis direction at the third position A-A′, is located in the +Y direction with respect to a wall surface P1b in the −Y direction, which is the other side of the protrusion portion 17 in the Y-axis direction at the first position B-B′. In addition, the wall surface P3b of the protrusion portion 17 in the −Y direction at the third position A-A′ is located in the −Y direction with respect to a wall surface P2b in the −Y direction, which is the other side in the Y-axis direction of the protrusion portion 17 at the second position C-C′.

The second surface 17b of the present embodiment is an inclined surface that is inclined in the −Z direction as going in the −Y direction as illustrated in FIGS. 4 and 5. Therefore, in the present embodiment, the wall surface P1b in the −Y direction at the first position B-B′, the wall surface P2b in the −Y direction at the second position C-C′, and the wall surface P3b in the −Y direction at the third position A-A′ are referred to as a center position of the second surface 17b inclined with respect to the Z-axis direction.

In addition, a position of the protrusion portion 17 on the −Y direction side is gradually changed in the −Y direction as a position in the X-axis direction is changed to the second position C-C′, the third position A-A′, and the first position B-B′. That is, the second surface 17b of the protrusion portion 17 on the discharge-side in the −Y direction is an inclined surface that is inclined in the −Y direction as going toward the second position C-C′, the third position A-A′, and the first position B-B′, that is, as going in the +X direction.

Further, by providing the protrusion portion 17, a flow of the ink in the −Y direction occurs at each of the first position B-B′, the second position C-C′, and the third position A-A′ on the +Z direction side of the protrusion portion 17. In FIG. 7, ink flows at the first position B-B′, the second position C-C′, and the third position A-A′ are respectively indicated by arrows as a first flow 201A, a second flow 202A, and a third flow 203A. In FIG. 7, a length of the arrow indicates a magnitude of the flow, that is, a flow rate.

In addition, the first surface 17a of the protrusion portion 17 is an inclined surface that is inclined in the −Y direction as going in the +X direction. Therefore, in addition to the first flow 201A, the second flow 202A, and the third flow 203A, a fourth flow 204A, which is a flow of the ink in a direction intersecting the first surface 17a at an acute angle in both the +X direction and the −Y direction, is generated. Therefore, the second flow 202A and the third flow 203A going in the −Y direction along the first surface 17a at the second position C-C′ and the third position A-A′ are reduced by the amount of ink branching to the fourth flow 204A, and the first flow 201A at the first position B-B′ is increased by the amount of the fourth flow 204A. In this manner, by reducing the third flow 203A at the third position A-A′, the flow of the ink that hits a meniscus can be reduced when the meniscus of the ink in the nozzle 21 is drawn into the nozzle communication portion 123. Therefore, breaking of the meniscus of the nozzle 21 due to the flow of the ink can be suppressed and an ejection failure of the ink droplets due to the breaking of the meniscus can be reduced, and the mixing of air bubbles due to the breaking of the meniscus can be suppressed. On the other hand, the first flow 201A of the ink at the first position B-B′ increases. Meanwhile, since the nozzle 21 is not present at a position overlapping the protrusion portion 17 in the +Z direction at the first position B-B′, the influence of the first flow 201A on the meniscus of the nozzle 21 can be reduced.

On the other hand, FIG. 8 illustrates a configuration in which a wall surface of the protrusion portion 17 in the +Y direction is provided to be at the same position in the Y-axis direction at the first position B-B′, the second position C-C′, and the third position A-A′, and a wall surface in the −Y direction is provided to be at the same position in the Y-axis direction at the first position B-B′, the second position C-C′, and the third position A-A′. FIG. 8 is a plan view of the pressure chamber 12 and the protrusion portion 17 of Comparative Example when viewed in the +Z direction. In Comparative Example in FIG. 8, on the +Z direction side of the protrusion portion 17, the first flow 201A, the second flow 202A, and the third flow 203A, which are ink flows in the −Y direction at the first position B-B′, the second position C-C′, and the third position A-A′, are generated. Then, the third flow 203A does not decrease due to the fourth flow 204A described above, and the third flow 203A becomes relatively large. Therefore, when a meniscus of the ink in the nozzle 21 is drawn into the nozzle communication portion 123, there is a concern that the meniscus may be broken by the third flow 203A coming into contact with the meniscus. When the meniscus is broken, an ejection failure in which the ink droplet is not ejected may occur, or air bubbles may be mixed into the nozzle 21. The same applies when the ink flows in the +Y direction in the nozzle flow path.

In the present embodiment, since the third flows 203A and 203B can be reduced, the breaking of the meniscus can be suppressed, and the ejection failure of the ink droplet can be suppressed.

In the present embodiment, the nozzle flow path is assumed to allow the ink to flow in the −Y direction, but the present disclosure is not particularly limited thereto, and for example, the nozzle flow path may allow the ink to flow in the +Y direction. As described above, by providing the protrusion portion 17, the flow of the ink in the +Y direction occurs at each of the first position B-B′, the second position C-C′, and the third position A-A′ on the +Z direction side of the protrusion portion 17. In FIG. 7, the ink flow in the +Y direction at the first position B-B′, the second position C-C′, and the third position A-A′ is indicated by arrows as a first flow 201B, a second flow 202B, and a third flow 203B, respectively. A length of the arrow indicates a magnitude of the flow rate, that is, a flow rate.

In addition, the second surface 17b of the protrusion portion 17 is an inclined surface that is inclined in the −Y direction as going in the +X direction. Therefore, in addition to the first flow 201B, the second flow 202B, and the third flow 203B, a fourth flow 204B, which is a flow of the ink in a direction intersecting the second surface 17b at an acute angle in both the −X direction and the +Y direction, is generated. Therefore, the first flow 201B and the third flow 203B going in the +Y direction along the second surface 17b at the first position B-B′ and the third position A-A′ are reduced by the amount of ink branching to the fourth flow 204B, and the second flow 202B of the ink in the +Y direction along the second surface 17b at the second position C-C′ is increased by the amount of fourth flow 204B. In this manner, by reducing the third flow 203B, the third flow 203B of the ink that hits the meniscus is reduced when the meniscus of the ink in the nozzle 21 is drawn into the nozzle communication portion 123. Therefore, the breaking of the meniscus of the nozzle 21 due to the flow of the ink can be suppressed, and the ejection failure of the ink droplets and the mixing of air bubbles from the nozzle 21 can be suppressed. On the other hand, the second flow 202B at the second position C-C′ increases. Meanwhile, since the nozzle 21 is not present at a position overlapping the protrusion portion 17 in the +Z direction at the second position C-C′, the influence on the meniscus of the nozzle 21 can be reduced.

On the other hand, as described above, a first piezoelectric element 301, a second piezoelectric element 302, and a third piezoelectric element 303 are stacked via the first diaphragm 51, the second diaphragm 52, and the third diaphragm 53 on the surface of the pressure chamber substrate 10 facing the −Z direction.

In the present embodiment, the first diaphragm 51, the second diaphragm 52, and the third diaphragm 53 have the same stack structure of the same material having the same thickness. Therefore, hereinafter, the first diaphragm 51, the second diaphragm 52, and the third diaphragm 53 are referred to as the diaphragm 50 when not distinguished. Of course, the first diaphragm 51, the second diaphragm 52, and the third diaphragm 53 may have different stack structures such as a film thickness and a material.

The first diaphragm 51 has, for example, an elastic film 50a made of silicon oxide provided on the pressure chamber substrate 10 side, and an insulator film 50b made of zirconium oxide disposed on a surface of the elastic film 50a facing the −Z direction. In the present embodiment, the second diaphragm 52 and the third diaphragm 53 are continuously provided with the first diaphragm 51. That is, the second diaphragm 52 and the third diaphragm 53 include the elastic film 50a and the insulator film 50b. The diaphragm 50 may be configured with only the elastic film 50a, may be configured with only the insulator film 50b, or may be configured with other films in addition to the elastic film 50a and the insulator film 50b. In the diaphragm 50 provided on the surface of the pressure chamber substrate 10 facing the −Z direction, in an opening of the surface of the pressure chamber substrate 10 facing the −Z direction, a portion covering the pressure chamber 12 is referred to as the first diaphragm 51, a portion covering the detection chamber 15 is referred to as the second diaphragm 52, and a portion covering the absorption chamber 14 is referred to as the third diaphragm 53. A recess portion serving as the pressure chamber 12, the ink supply path 13, the absorption chamber 14, and the detection chamber 15 may be formed by etching the surface of the pressure chamber substrate 10 facing the +Z direction, in the −Z direction. In this case, since a bottom surface of the recess portion serves as the elastic film 50a, the pressure chamber substrate 10 and the elastic film 50a, which is a part of the diaphragm 50, are integrally formed. Further, the entire diaphragm 50 and the pressure chamber substrate 10 may be integrally formed.

All of the first piezoelectric element 301, the second piezoelectric element 302, and the third piezoelectric element 303 have an electrode on an upper surface facing the −Z direction and a lower surface facing the +Z direction of a piezoelectric body configured with a piezoelectric material made of a composite oxide having a perovskite structure represented by the general formula ABO₃. When a voltage is applied between the upper and lower electrodes, the piezoelectric body interposed between the two electrodes is deformed by an electrostriction effect, and on the other hand, when force that deforms the piezoelectric body from the outside is applied, a voltage is generated between the electrodes by a piezoelectric effect. In the present embodiment, the first piezoelectric element 301, the second piezoelectric element 302, and the third piezoelectric element 303 have the same general configuration, but the first piezoelectric element 301 is used as a piezoelectric element that generates vibration by applying a voltage between electrodes to the first diaphragm 51, and the second piezoelectric element 302 is used as a piezoelectric element that generates pressure by a vibration applied from the outside to the second diaphragm 52, and thereby detects vibration. The configuration of the third piezoelectric element 303 is the same as the configuration of the other piezoelectric elements, but the upper and lower electrodes are not electrically coupled to each other, and the third piezoelectric element 303 is used as a mass for absorbing a pressure change of the ink in the absorption chamber 14. In addition, in the present embodiment, the first piezoelectric element 301, the second piezoelectric element 302, and the third piezoelectric element 303 are formed at the same time with the same material. Therefore, manufacturing costs can be reduced. Of course, the first piezoelectric element 301, the second piezoelectric element 302, and the third piezoelectric element 303 may be formed by different manufacturing processes using materials which are different from each other.

First, the first piezoelectric element 301 will be described. The first piezoelectric element 301 includes a first lower electrode 61, a first piezoelectric layer 71, and a first upper electrode 81 sequentially stacked on the first diaphragm 51. Such a first piezoelectric element 301 is also referred to as a piezoelectric actuator, and refers to a portion including the first lower electrode 61, the first piezoelectric layer 71, and the first upper electrode 81. In the present embodiment, the first piezoelectric element 301 is formed for each pressure chamber 12. That is, a plurality of first piezoelectric elements 301 are provided in parallel on the first diaphragm 51 of the pressure chamber substrate 10 in the X-axis direction. The plurality of first piezoelectric elements 301 are energy generation elements that cause a pressure change in the ink in the pressure chamber 12. In general, one electrode of any one of the first piezoelectric elements 301 is configured as an independent individual electrode for each first piezoelectric element 301, and the other electrode is configured as a common electrode common to the plurality of first piezoelectric elements 301. In the present embodiment, the first lower electrode 61 is cut for each pressure chamber 12 to function as an individual electrode of each first piezoelectric element 301, and the first upper electrode 81 is continuously provided over the plurality of pressure chambers 12 to function as a common electrode of a plurality of first piezoelectric elements 301. Of course, the first lower electrode 61 may constitute the common electrode, and the first upper electrode 81 may constitute the individual electrode. The first piezoelectric element 301 is deformed to bend and deform the first diaphragm 51, thereby causing a pressure change in the ink in the pressure chamber 12.

As illustrated in FIGS. 3 and 4, a first individual lead electrode 91, which is a lead wiring, is drawn out from the first lower electrode 61 of the first piezoelectric element 301. In addition, a common lead electrode (not illustrated) which is a lead wiring is drawn from the first upper electrode 81. A flexible substrate 110, which is a flexible wiring substrate, is coupled to an end portion opposite to an end portion of the first individual lead electrode 91 and the common lead electrode (not illustrated) coupled to the first piezoelectric element 301. The flexible substrate 110 is electrically coupled to a control section 4, and exchanges a signal for driving the first piezoelectric element 301, a detection signal corresponding to the residual vibration generated in the second piezoelectric element 302, and the like with the control section 4 via a control circuit 111. That is, the control circuit 111 includes a plurality of switching elements for selecting whether or not to supply a drive signal for driving each of the first piezoelectric elements 301 to each first piezoelectric element 301. That is, the flexible substrate 110 in the present embodiment is a chip on film (COF). The flexible substrate 110 may not be provided with the control circuit 111. That is, the flexible substrate 110 may be a flexible flat cable (FFC), a flexible printed circuit (FPC), or the like.

The third diaphragm 53 covers a portion of the opening of the pressure chamber substrate 10 facing the −Z direction corresponding to the absorption chamber 14. The third diaphragm 53 is continuously formed with the first diaphragm 51 as described above. That is, the third diaphragm 53 has the elastic film 50a and the insulator film 50b. The third diaphragm 53 is deformed by the pressure of the ink in the absorption chamber 14, and absorbs a pressure fluctuation of the ink in the absorption chamber 14.

In addition, the third piezoelectric element 303 is stacked on a surface of the third diaphragm 53 facing the −Z direction. The third piezoelectric element 303 is disposed at a position overlapping the absorption chamber 14 when viewed in the Z-axis direction. The third piezoelectric element 303 has a third lower electrode 63, a third piezoelectric layer 73, and a third upper electrode 83 sequentially stacked on the third diaphragm 53, in the same manner as the first piezoelectric element 301. The third lower electrode 63, the third piezoelectric layer 73, and the third upper electrode 83 are made of the same material as the first lower electrode 61, the first piezoelectric layer 71, and the first upper electrode 81 of the first piezoelectric element 301. The third piezoelectric element 303 is different from the first piezoelectric element 301 in that the third lower electrode 63 is continuously provided over the X-axis direction. Of course, the third lower electrode 63 may be provided by being divided into a plurality for one absorption chamber 14. In addition, the third piezoelectric element 303 is not always necessary, and the third piezoelectric element 303 may not be provided.

The second diaphragm 52 covers a portion of the opening of the pressure chamber substrate 10 facing the −Z direction corresponding to the detection chamber 15. The second diaphragm 52 is continuously configured with the first diaphragm 51. That is, the second diaphragm 52 has the elastic film 50a and the insulator film 50b. Of course, each layer of the second diaphragm 52 may be formed at the same time as the first diaphragm 51, or may be formed individually. The second diaphragm 52 is deformable in response to a pressure fluctuation of the ink in the detection chamber 15. The plurality of second diaphragms 52 individually vary corresponding to the plurality of detection chambers 15.

In addition, the second piezoelectric element 302 is stacked on a surface of the second diaphragm 52 facing the −Z direction. The second piezoelectric element 302 is disposed at a position overlapping the detection chamber 15 when viewed in the Z-axis direction. The second piezoelectric element 302 includes a second lower electrode 62, a second piezoelectric layer 72, and a second upper electrode 82 sequentially stacked on the second diaphragm 52, in the same manner as the first piezoelectric element 301. In the present embodiment, the second piezoelectric element 302 is formed in each of the detection chambers 15. That is, the plurality of second piezoelectric elements 302 are provided in parallel on the second diaphragm 52 of the pressure chamber substrate 10 in the X-axis direction. The plurality of second piezoelectric elements 302 are detection elements that detect a pressure fluctuation in the detection chamber 15. In addition, the second lower electrode 62 of the second piezoelectric element 302 is divided for each detection chamber 15 and functions as an individual electrode of each second piezoelectric element 302, and the second upper electrode 82 is continuously provided over the plurality of detection chambers 15 and functions as a common electrode of the plurality of second piezoelectric elements 302. Of course, the second lower electrode 62 may constitute the common electrode, and the second upper electrode 82 may constitute the individual electrode. The second lower electrode 62, the second piezoelectric layer 72, and the second upper electrode 82 of the second piezoelectric element 302 have the same electrode arrangement, structure, material, and the like as the first lower electrode 61, the first piezoelectric layer 71, and the first upper electrode 81 of the first piezoelectric element 301. Therefore, detailed description thereof will be omitted. In addition, the second lower electrode 62 and the second upper electrode 82 of the second piezoelectric element 302 are also coupled to the flexible substrate 110 via a second individual lead electrode 92 and a second common lead electrode (not illustrated) in the same manner as the first lower electrode 61 and the first upper electrode 81 of the first piezoelectric element 301.

Here, when the first piezoelectric element 301 causes a pressure fluctuation in the ink in the pressure chamber 12 and ejects an ink droplet from the nozzle 21, the pressure fluctuation in the pressure chamber 12 remains for a predetermined period even after the ink droplet is ejected. This is called residual vibration. Since the pressure fluctuation of the ink in the pressure chamber 12 is also propagated to the ink in the detection chamber 15 via the collection path 124, the second piezoelectric element 302 detects the residual vibration of the detection chamber 15. That is, the second piezoelectric element 302 detects the residual vibration as a voltage signal by a generated electromotive force when the residual vibration of the ink in the detection chamber 15 varies. The control circuit 111 extracts information on a state of the residual vibration, for example, a period, an amplitude, and the like of the residual vibration from the voltage signal generated in the second piezoelectric element 302, and outputs the information to the control section 4. The control section 4 detects an ejection failure of the ink droplet from the information such as the period and the amplitude of the residual vibration.

The protective substrate 30 having substantially the same size as the pressure chamber substrate 10 is joined to the surface of the pressure chamber substrate 10 facing the −Z direction. The protective substrate 30 has accommodation sections 31A to 31C which are spaces for protecting the first piezoelectric element 301, the second piezoelectric element 302, and the third piezoelectric element 303, respectively. The accommodation sections 31A to 31C have a recessed shape that opens on a surface of the protective substrate 30 facing the +Z direction. The plurality of first piezoelectric elements 301 are accommodated in the accommodation section 31A. The plurality of second piezoelectric elements 302 are accommodated in the accommodation section 31B. The single third piezoelectric element 303 is accommodated in the accommodation section 31C. Further, the protective substrate 30 has an opening portion 32 penetrating in the Z-axis direction between the two accommodation sections 31A and accommodation section 31B disposed side by side in the Y-axis direction. Each end portion of the first individual lead electrode 91 drawn from each electrode of the first piezoelectric element 301 and a first common lead electrode (not illustrated), and the second individual lead electrode 92 drawn from each electrode of the second piezoelectric element 302 and a second common lead electrode (not illustrated) is extended to be exposed in the opening portion 32. The first individual lead electrode 91, the first common lead electrode, the second individual lead electrode 92, and the second common lead electrode are electrically coupled to the flexible substrate 110 in the opening portion 32. The opening portion 32 is disposed at a position overlapping the collection path 124 when viewed in the Z-axis direction. That is, the flexible substrate 110 is joined to the various lead electrodes 91 and 92 and the like drawn out from the first piezoelectric element 301 and the second piezoelectric element 302 on the diaphragm 50 at a position that overlaps the collection path 124 when viewed in the −Z direction, which is the −Z direction of the diaphragm 50. That is, the flexible substrate 110 is coupled to the diaphragm 50 between the pressure chamber 12 and the detection chamber 15 in the Y-axis direction. That is, the flexible substrate 110 is coupled to the diaphragm 50 at a position overlapping a portion of the pressure chamber substrate 10, at which the flow path is not provided when viewed in the −Z direction. Here, the diaphragm 50 is relatively thin and easily deformed to apply a pressure to the pressure chamber 12 and to be deformed by the pressure fluctuation in the detection chamber 15. Therefore, for example, when a collection path is provided in the pressure chamber substrate 10, the diaphragm 50 on the collection path is thin, and the flexible substrate 110 is coupled to the diaphragm 50 on the collection path, so that the diaphragm 50 is easily cracked by stress when the flexible substrate 110 is coupled. In the present embodiment, the collection path 124 is provided on the communication plate 120, and the flexible substrate 110 is coupled to the diaphragm 50 at a position overlapping a portion of the pressure chamber substrate 10, at which the flow path is not provided when viewed in the −Z direction. Therefore, a region of the diaphragm 50 to which the flexible substrate 110 is coupled is supported by the pressure chamber substrate 10. Therefore, occurrence of the crack in the diaphragm 50 due to the stress can be suppressed when the flexible substrate 110 is coupled to the diaphragm 50.

As such a protective substrate 30, a silicon substrate or an SOI substrate is preferably used. The material of the protective substrate 30 is not limited thereto, and a glass substrate, various ceramic substrates, a metal substrate such as a stainless steel substrate, or the like may be used.

The protective substrate 30 has a flow path 33A constituting a part of the supply-side common liquid chamber 100A and a flow path 33B constituting a part of the discharge-side common liquid chamber 100B. The flow paths 33A and 33B are provided to penetrate the protective substrate 30 in the Z-axis direction. The flow path 33A is located in the +Y direction of the accommodation section 31C, and the flow path 33B is located in the −Y direction of the accommodation section 31B.

The case 40 is located on the −Z direction side of the protective substrate 30. The case 40 has a flow path 41A constituting a part of the supply-side common liquid chamber 100A and a flow path 41B constituting a part of the discharge-side common liquid chamber 100B. The flow path 41A is disposed at a position overlapping the flow path 33A of the protective substrate 30 when viewed in the Z-axis direction, and communicates with the flow path 33A. Further, the flow path 41B is disposed at a position overlapping the flow path 33B of the protective substrate 30 when viewed in the Z-axis direction, and communicates with the flow path 33B. The flow paths 41A and 41B have a recessed shape that opens to a surface of the case 40 facing the +Z direction. Further, the case 40 is provided with a supply port 42 for supplying an ink to the flow path 41A and a discharge port 43 for discharging the ink in the flow path 41B to the outside. For example, the case 40 is made of metal or resin.

The supply-side common liquid chamber 100A of the present embodiment is configured with the flow path 41A provided in the case 40, the flow path 33A provided in the protective substrate 30, the flow path 16A provided in the pressure chamber substrate 10, and the flow path 121A provided in the communication plate 120. The discharge-side common liquid chamber 100B is configured with the flow path 41B provided in the case 40, a flow path 33B provided in the protective substrate 30, the flow path 16B provided in the pressure chamber substrate 10, and the flow path 121B provided in the communication plate 120. An ink from a liquid storage portion (not illustrated) is supplied to the supply-side common liquid chamber 100A via the supply port 42. The ink in the supply-side common liquid chamber 100A is supplied to the discharge-side common liquid chamber 100B via the absorption chamber 14, the ink supply path 13, the pressure chamber 12, the collection path 124, and the detection chamber 15. The ink in the discharge-side common liquid chamber 100B is discharged from the discharge port 43 to the outside of the liquid ejecting head H.

A substrate constituting each flow path of the supply-side common liquid chamber 100A and the discharge-side common liquid chamber 100B may not be the same as the substrate described in the present embodiment. For example, the protective substrate 30 or the pressure chamber substrate 10 may not cover an entire region of the communication plate 120 in the Y-axis direction, and instead, another substrate having a long length in the Z-axis direction may be provided at both end portions of the communication plate 120 in the Y-axis direction, and a flow path communicating with the flow path 121A and a flow path communicating with the flow path 121B may be formed to penetrate the other substrate in the Z-axis direction.

Further, the case 40 has a through-hole 44 that communicates with the opening portion 32 of the protective substrate 30. The through-hole 44 is provided to penetrate the case 40 in the Z-axis direction. The flexible substrate 110 coupled to the first piezoelectric element 301 and the second piezoelectric element 302 on the diaphragm 50 of the pressure chamber substrate 10 flows out to a surface side of the case 40 facing the −Z direction via the opening portion 32 of the protective substrate 30 and the through-hole 44 of the case 40.

In addition, a supply-side compliance substrate 130A and a discharge-side compliance substrate 130B are provided on a surface of the communication plate 120 facing the +Z direction in which the flow paths 121A and 121B open. In the present embodiment, the supply-side compliance substrate 130A and the discharge-side compliance substrate 130B have the same configuration. Therefore, the supply-side compliance substrate 130A will be described below, but the discharge-side compliance substrate 130B has the same configuration.

In the present embodiment, the compliance substrate 130A includes a sealing film 131 made of a flexible thin film, and a fixing substrate 132 made of a hard material such as metal. A region of the fixing substrate 132 facing the common liquid chamber 100A is an opening portion 133 that is completely removed in a thickness direction, and a surface of the common liquid chamber 100A in the +Z direction is a compliance portion 134 defined only by the sealing film 131. By deforming the compliance portion 134 in this manner, a pressure fluctuation of the ink inside the common liquid chamber 100A can be absorbed and occurrence of a variation in the ejection characteristics such as a flight speed and a weight of the ink droplet ejected from the nozzles 21 can be suppressed.

In the present embodiment, the pressure chamber substrate 10 and the communication plate 120 are examples of a “flow path substrate”. In addition, the X-axis direction is an example of an “arrangement direction”, the +X direction is “one side of the arrangement direction”, and the −X direction is “the other side of the arrangement direction”. In addition, the Y-axis direction is an example of an “extending direction”, the +Y direction side is “one side of the extending direction”, and the −Y direction is “the other side of the extending direction”. In addition, the Z-axis direction is an example of a stack direction, the −Z direction side is an example of “one side of the stack direction”, and the +Z direction side is an example of “the other side of the stack direction”.

### Other Embodiments

Although one embodiment of the present disclosure is described above, the basic configuration of the present disclosure is not limited to the above description.

For example, in Embodiment 1 described above, the collection path 124 is formed in the recess portion provided in the communication plate 120. However, the present disclosure is not particularly limited thereto, and the collection path 124 may be provided to penetrate the communication plate 120 in the Z-axis direction, may be provided on the pressure chamber substrate 10, or may be provided on both the pressure chamber 12 and the communication plate 120.

In addition, in Embodiment 1 described above, the first surface 17a is an inclined surface that is inclined toward the +Y direction as viewed in the +Z direction and toward the +X direction, but the present disclosure is not particularly limited thereto. For example, the first surface 17a may be provided with a step shape toward the second position C-C′, the third position A-A′, and the first position B-B′ when viewed in the +Z direction. That is, the first surface 17a may be a step surface instead of an inclined surface. Even when the first surface 17a is the step surface in this manner, the ink hitting the third position A-A′ of the protrusion portion 17 is formed into the fourth flow 204A flowing toward the first position B-B′ side located in the −Y direction with respect to the third position A-A', that is, in the +X direction. Therefore, the third flow 203A flowing toward the third position A-A′ in the −Y direction can be reduced, and the breaking of the meniscus pulled from the nozzle 21 can be suppressed. The same is applied to the second surface 17b.

In addition, in Embodiment 1 described above, both the first surface 17a and the second surface 17b of the protrusion portion 17 are inclined surfaces inclined in both the X-axis direction and the Y-axis direction when viewed in the +Z direction, but the present disclosure is not particularly limited thereto, and only the surface facing the upstream at which the ink flows may be used as the inclined surface.

In addition, in Embodiment 1 described above, the liquid ejecting head H in which the ink circulates is exemplified, but the present disclosure is not particularly limited thereto, and a liquid ejecting head in which the ink does not circulate may be used.

In addition, in Embodiment 1 described above, although the thin film type first piezoelectric element 301 to the third piezoelectric element 303 are used as an energy generation element that generates a pressure change in the pressure chamber 12, the present disclosure is not limited thereto, and for example, a thick film type piezoelectric actuator formed by a method such as attaching a green sheet, a longitudinal vibration type piezoelectric actuator that alternately stacks a piezoelectric material and an electrode forming material and expands and contracts in the axial direction, and the like can be used as the energy generation element. In addition, as the “energy generation element”, for example, an element in which a heat generating element is disposed in the pressure chamber 12 to eject a droplet from the nozzle 21 by bubbles generated due to the heat of the heat generating element, a so-called electrostatic actuator that generates static electricity between a diaphragm and an electrode, deforms the diaphragm by the electrostatic force, and ejects the droplet from the nozzle 21, and the like can be used.

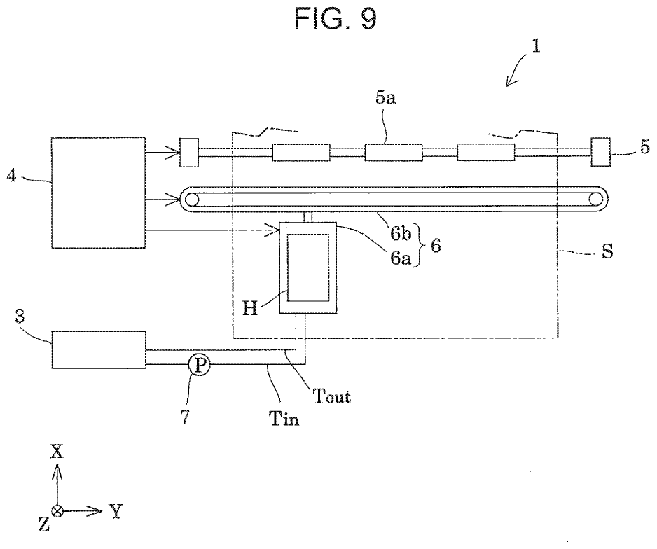

In addition, the liquid ejecting head H of each embodiment described above is mounted on the liquid ejecting apparatus 1. FIG. 9 is a view illustrating a schematic configuration of the liquid ejecting apparatus 1 according to one embodiment of the present disclosure.

As illustrated in the drawing, a liquid ejecting apparatus 1 is a so-called serial printer that includes the liquid ejecting head H and transports a medium S in the X-axis direction, reciprocates the liquid ejecting head H in the Y-axis direction, and performs printing by ejecting a liquid from the liquid ejecting head H toward the medium S in the +Z direction. For the medium S, any material such as recording paper, resin film, or cloth can be used. In addition, a direction in which the liquid ejecting head H reciprocates is not limited to the Y-axis direction, and may be a direction inclined with respect to both the X-axis direction and the Y-axis direction.

The liquid ejecting apparatus 1 includes the liquid ejecting head H, the liquid storage portion 3, the control section 4, a transport mechanism 5 that sends out the medium S, and a movement mechanism 6.

The liquid ejecting head H ejects the liquid supplied from the liquid storage portion 3 as a droplet in the +Z direction.

The liquid storage portion 3 stores the liquid to be ejected from the liquid ejecting head H. The liquid storage portion 3 includes, for example, a cartridge that is attachable and detachable to the liquid ejecting apparatus 1, a bag-shaped ink pack made of a flexible film, an ink tank that can be replenished with the ink, and the like.

A supply tube Tin and a discharge tube Tout are coupled to the liquid storage portion 3.

The supply tube Tin is a tube through which the ink in the liquid storage portion 3, which is pressurized to a predetermined pressure by a pump 7, is supplied to the liquid ejecting head H. The discharge tube Tout is a tube for collecting the ink collected from the liquid ejecting head H to the liquid storage portion 3.

Although not particularly illustrated, the liquid storage portion 3 may be divided into a main tank and a sub-tank. The sub-tank may be coupled to the liquid ejecting head H, and the liquid consumed by ejecting the droplets from the liquid ejecting head H may be replenished from the main tank to the sub-tank.

The control section 4 includes, for example, a control device such as a central processing unit (CPU) or a field programmable gate array (FPGA), and a storage device such as a semiconductor memory. The control section 4 also includes a power supply device that supplies power supplied from an external power supply such as a commercial power supply to each element of the liquid ejecting apparatus 1. The control section 4 is electrically coupled to the liquid ejecting head H via the flexible substrate 110 described above. The control section 4 comprehensively controls each element of the liquid ejecting apparatus 1 by the control device executing a program stored in the storage device.

The transport mechanism 5 transports the medium S in the X-axis direction, and has, for example, a transport roller 5a that rotates by a transport motor controlled and driven by the control section 4.

The movement mechanism 6 is a mechanism for reciprocating the liquid ejecting head H in the Y-axis direction, and includes a holder 6a that holds the liquid ejecting head H, and a transport belt 6b which is an endless belt installed along the Y-axis direction. The control section 4 rotates the transport belt 6b by controlling driving of a transport motor (not illustrated), thereby reciprocating the liquid ejecting head H in the Y-axis direction together with the holder 6a fixed to the transport belt 6b. The liquid storage portion 3 can also be mounted on the holder 6a together with the liquid ejecting head H. The holder 6a holds one liquid ejecting head H, but the holder 6a may hold two or more liquid ejecting heads H.

The liquid ejecting head H performs an ejection operation of ejecting the ink supplied from the liquid storage portion 3 as ink droplets in the +Z direction from each of the plurality of nozzles 21 under the control of the control section 4. The control section 4 functions as an ejection control section that controls ejection of the ink by the liquid ejecting head H. The ejection operation performed by the liquid ejecting head H is performed in parallel with transportation of the medium S in the X-axis direction that is performed by the transport mechanism 5 and reciprocation of the liquid ejecting head H in the Y-axis direction that is caused by the movement mechanism 6, so that so-called printing, in which ink is applied to the medium S, is performed.

In the example illustrated in FIG. 9, the liquid ejecting apparatus 1 is an example in which the liquid ejecting head H is mounted on the holder 6a and moves in the main scanning direction, but the present disclosure is not particularly limited thereto, and the present disclosure can be applied to, for example, a so-called line printer that performs printing by fixing the liquid ejecting head H and moving the medium S in the sub-scanning direction.

Further, the present disclosure is intended for a wide range of liquid ejecting heads and liquid ejecting apparatuses, and can of course be applied to liquid ejecting heads and liquid ejecting apparatuses that eject liquids other than ink. Other liquid ejecting heads include, for example, various recording heads used in image recording apparatuses such as printers, a color material ejecting head used in the manufacture of color filters for liquid crystal displays, an electrode material ejecting head used in the formation of electrodes for organic EL displays, field emission displays (FEDs), and the like, and a bioorganic material ejecting head used in the manufacture of biochips. The present disclosure can also be applied to a liquid ejecting apparatus including such a liquid ejecting head.

### Additional Notes

From the examples illustrated above, for example, the following configurations can be understood.

According to Aspect 1 which is a preferred aspect, there is provided a liquid ejecting head including: a flow path substrate in which a plurality of nozzle flow paths, through which a liquid flows and which extend in an extending direction, are arranged in an arrangement direction intersecting the extending direction; and a nozzle substrate in which a plurality of nozzles that are directly coupled to the nozzle flow paths and that eject liquids are arranged in the arrangement direction, the flow path substrate and the nozzle substrate being stacked in this order from one side to another side along a stack direction intersecting the arrangement direction and the extending direction, in which the flow path substrate has a protrusion portion protruding toward the other side along the stack direction, in one of the nozzle flow paths, the protrusion portion is continuously provided over a first position at which the protrusion portion does not overlap the nozzle when viewed in the stack direction, the first position being a position of an end portion on one side in the arrangement direction, a second position at which the protrusion portion does not overlap the nozzle when viewed in the stack direction, the second position being a position of an end portion on the other side in the arrangement direction, and a third position at which the protrusion portion overlaps the nozzle when viewed in the stack direction, the third position being a position between the first position and the second position in the arrangement direction, and a wall surface of the protrusion portion on one side in the extending direction at the third position is located on the one side in the extending direction with respect to a wall surface of the protrusion portion on the one side in the extending direction at the first position, and is located on the other side in the extending direction with respect to a wall surface of the protrusion portion on the one side in the extending direction at the second position. Accordingly, the wall surface on the one side in the extending direction at the third position is located on the one side in the extending direction with respect to the wall surface on the one side in the extending direction at the first position, and is located on the other side in the extending direction with respect to the wall surface on the one side in the extending direction at the second position. Therefore, a flow of the liquid flowing on a nozzle side in the stack direction of the protrusion portion at the third position can be reduced. Therefore, breaking of a meniscus of the liquid drawn from the nozzle due to the flow of the liquid at the third position can be suppressed, and an ejection failure of a liquid droplet and mixing of air bubbles from the nozzle can be suppressed. In addition, the flow of the liquid flowing on the nozzle side of the protrusion portion in the stack direction is increased at the first position. Meanwhile, since the first position does not overlap the nozzle when viewed in the stack direction, the influence on the meniscus can be reduced.

According to Aspect 2 which is a specific example of Aspect 1, a position of the protrusion portion on the one side in the extending direction is gradually changed from the one side to the other side in the extending direction as a position of the protrusion portion in the arrangement direction is changed to the second position, the third position, and the first position. Accordingly, by gradually changing the position of the protrusion portion on the one side in the extending direction in the arrangement direction, it is easy to form a flow of the liquid flowing in the arrangement direction at the end portion of the protrusion portion on the one side in the extending direction, and it is easy to reduce the flow of the liquid in the extending direction at the third position.

According to Aspect 3 which is a specific example of Aspect 1 or 2, a wall surface of the protrusion portion on the other side in the extending direction at the third position is located on the one side in the extending direction with respect to a wall surface of the protrusion portion on the other side in the extending direction at the first position, and is located on the other side in the extending direction with respect to a wall surface of the protrusion portion on the other side in the extending direction at the second position. Accordingly, even when the liquid flows from the other side to the one side of the extending direction with respect to the protrusion portion, the flow of the liquid at the third position directly above the nozzle is reduced, the breaking of the meniscus is suppressed, and the ejection failure of the liquid droplet and the mixing of the air bubbles from the nozzle can be suppressed.

According to Aspect 4 which is a specific example of any one of Aspects 1 to 3, the flow path substrate is further provided with a common supply flow path which communicates with the plurality of nozzle flow paths and through which the liquid is supplied to the nozzle flow path, and a common discharge flow path which communicates with the plurality of nozzle flow paths and through which the liquid is discharged to the nozzle flow path, and in the nozzle flow path, the liquid flows from the one side to the other side in the extending direction. Accordingly, when the liquid flows from the one side to the other side in the extending direction, the flow of the liquid directly above the nozzle is reduced, the breaking of the meniscus is suppressed, and the ejection failure of the liquid droplet and the mixing of air bubbles from the nozzle can be suppressed.

According to Aspect 5 which is a specific example of any one of Aspects 1 to 3, the flow path substrate is further provided with a common supply flow path which communicates with the plurality of nozzle flow paths and through which the liquid is supplied to the nozzle flow path, and a common discharge flow path which communicates with the plurality of nozzle flow paths and through which the liquid is discharged to the nozzle flow path, and in the nozzle flow path, the liquid flows from the other side to the one side in the extending direction. Accordingly, when the liquid flows from the other side to one side in the extending direction, the flow of the liquid directly above the nozzle is reduced, the breaking of the meniscus is suppressed, and the ejection failure of the liquid droplet and the mixing of air bubbles from the nozzle can be suppressed.

According to Aspect 6 which is a specific example of any one of Aspects 1 to 5, the nozzle flow path includes a first pressure chamber and a second pressure chamber that apply a pressure to the liquid by driving an energy generation element, and a nozzle communication portion that directly communicates with the first pressure chamber, the second pressure chamber, and the nozzle.

According to Aspect 7 which is a specific example of any one of Aspects 1 to 6, the first pressure chamber and the second pressure chamber are separated by the protrusion portion.

According to Aspect 8 which is a specific example of Aspect 6 or 7, the flow path substrate includes a pressure chamber substrate in which the first pressure chamber and the second pressure chamber are provided, and a communication plate in which the nozzle communication portion is provided.

According to Aspect 9 which is a specific example of any one of Aspects 1 to 8, at each of the first position, the second position, and the third position in the arrangement direction, when viewed in the arrangement direction, the wall surface of the protrusion portion on the one side in the extending direction extends in a direction intersecting with both the extending direction and the stack direction. Accordingly, the flow of the liquid along the wall surface can be made smooth, retention of the air bubbles due to the retention of the liquid, and the like can be suppressed.

According to Aspect 10 which is a preferred aspect, there is provided a liquid ejecting apparatus including: the liquid ejecting head according to any one of the aspects described above; and a control section that controls an ejection operation of the liquid ejecting head. Accordingly, the liquid ejecting apparatus that suppresses an ejection failure of the droplet can be realized.

What is claimed is:

1. A liquid ejecting head comprising:
a flow path substrate in which a plurality of nozzle flow paths, through which a liquid flows and which extend in an extending direction, are arranged in an arrangement direction intersecting the extending direction; and
a nozzle substrate in which a plurality of nozzles that are directly coupled to the nozzle flow paths and that eject liquids are arranged in the arrangement direction,
the flow path substrate and the nozzle substrate being stacked in this order from one side to another side along a stack direction intersecting the arrangement direction and the extending direction, wherein
the flow path substrate has a protrusion portion protruding toward the other side along the stack direction,
in one of the nozzle flow paths, the protrusion portion is continuously provided over a first position at which the protrusion portion does not overlap the nozzle when viewed in the stack direction, the first position being a position of an end portion on one side in the arrangement direction, a second position at which the protrusion portion does not overlap the nozzle when viewed in the stack direction, the second position being a position of an end portion on the other side in the arrangement direction, and a third position at which the protrusion portion overlaps the nozzle when viewed in the stack direction, the third position being a position between the first position and the second position in the arrangement direction, and
a wall surface of the protrusion portion on one side in the extending direction at the third position is located on the one side in the extending direction with respect to a wall surface of the protrusion portion on the one side in the extending direction at the first position, and is located on the other side in the extending direction with respect to a wall surface of the protrusion portion on the one side in the extending direction at the second position.

2. The liquid ejecting head according to claim 1, wherein
a position of the protrusion portion on the one side in the extending direction is gradually changed from the one side to the other side in the extending direction as a position of the protrusion portion in the arrangement direction is changed to the second position, the third position, and the first position.

3. The liquid ejecting head according to claim 1, wherein
a wall surface of the protrusion portion on the other side in the extending direction at the third position is located on the one side in the extending direction with respect to a wall surface of the protrusion portion on the other side in the extending direction at the first position, and is located on the other side in the extending direction with respect to a wall surface of the protrusion portion on the other side in the extending direction at the second position.

4. The liquid ejecting head according to claim 1, wherein
the flow path substrate is further provided with
a common supply flow path which communicates with the plurality of nozzle flow paths and through which the liquid is supplied to the nozzle flow path, and
a common discharge flow path which communicates with the plurality of nozzle flow paths and through which the liquid is discharged to the nozzle flow path, and
in the nozzle flow path, the liquid flows from the one side to the other side in the extending direction.

5. The liquid ejecting head according to claim 1, wherein
the flow path substrate is further provided with
a common supply flow path which communicates with the plurality of nozzle flow paths and through which the liquid is supplied to the nozzle flow path, and
a common discharge flow path which communicates with the plurality of nozzle flow paths and through which the liquid is discharged to the nozzle flow path, and
in the nozzle flow path, the liquid flows from the other side to the one side in the extending direction.

6. The liquid ejecting head according to claim 1, wherein
the nozzle flow path includes a first pressure chamber and a second pressure chamber that apply a pressure to the liquid by driving an energy generation element, and a nozzle communication portion that directly communicates with the first pressure chamber, the second pressure chamber, and the nozzle.

7. The liquid ejecting head according to claim 6, wherein
the first pressure chamber and the second pressure chamber are separated by the protrusion portion.

8. The liquid ejecting head according to claim 6, wherein
the flow path substrate includes
a pressure chamber substrate in which the first pressure chamber and the second pressure chamber are provided, and
a communication plate in which the nozzle communication portion is provided.

9. The liquid ejecting head according to claim 1, wherein
at each of the first position, the second position, and the third position in the arrangement direction, when viewed in the arrangement direction, the wall surface of the protrusion portion on the one side in the extending direction extends in a direction intersecting with both the extending direction and the stack direction.

10. A liquid ejecting apparatus comprising:
the liquid ejecting head according to claim 1; and
a control section that controls an ejection operation of the liquid ejecting head.
